(19) United States
(12) Patent Application Publication
(10) Pub. No.: US 2013/0112895 A1
(43) Pub. Date: May 9, 2013

(54) Method for Characterising an Agri-Food Product and Device for Implementing Such a Method

(71) Applicants: Inés Birlouez-Aragon, Ermont (FR); Jad Rizkallah, Beyrouth (LB)

(72) Inventors: Inés Birlouez-Aragon, Ermont (FR); Jad Rizkallah, Beyrouth (LB)

(73) Assignee: SPECTRALYS INNOVATION, Romainville (FR)

(21) Appl. No.: 13/704,433

(22) PCT Filed: Jun. 15, 2011
(86) PCT No.: PCT/IB11/52600

§ 371 Date: Jan. 16, 2013

(30) Foreign Application Priority Data
Jun. 16, 2010 (FR) 1002549

(51) Int. Cl. G01J 3/44

(52) U.S. Cl. CPC G01J 3/4406
USPC 250/459.1; 250/458.1; 250/461.1

(57) ABSTRACT

The invention relates to a method for characterising one or more samples of an agri-food product, in particular intended for determining the naturality, freshness and authenticity of such a product and/or the conformity of same with a target product. The method of the invention is characterised in that it comprises: acquiring a plurality of natural fluorescence spectra of the sample; applying a multivariate or multi-path analysis method to said spectra, wherein said method provides a limited number F of variables representing said or each sample, in order to enable the representation thereof by a point (PE) in a space having F dimensions; calculating a distance (D) between said point representing said or each sample and a target (C1) representing one or more reference samples; and determining a characteristic of said or each sample according to said distance (D).

The invention relates to a spectroscopic method for characterizing an agri-food product, in particular intended for determining the naturality, freshness and authenticity of such a product, or even the conformity of same with a target product. The invention also relates to a device for implementing such a method.

The method is based on chemometric methods, and in particular on multivariate or, preferably, multi-way statistical analysis of natural-fluorescence spectra. Multi-way analysis is the natural extension of multivariate analysis when the data are arranged in tables with three or more ways. In this respect, reference may be made to the reference work by R. Bro, “Multi-way Analysis in the Food Industry Models, Algorithms, and Applications”, PhD thesis, University of Amsterdam, 1998.

The “naturality” and the “freshness” of stored or transformed agri-food products—i.e. their proximity with respect to the initial fresh products—are important parameters both for consumers and for producers. Unfortunately, these parameters are difficult to define precisely, and even more difficult to quantify. The invention is in fact directed toward enabling such a quantification.

The method of the invention also makes it possible to evaluate the “authenticity” or the “standardization” of an agri-food product compared with a reference product (region of origin, land, manufacturing method, etc.) or “standard” product.

In general, the concepts of naturality (a), freshness (b), authenticity (c) or standardization (c′) denote the modifications of qualities of a product, revealed by the changes in its physicochemical properties compared with a natural product which is nontransformed (a), fresh without storage (b), authentic according to precise and recognized specifications (c), and standard according to specifications internal to the company which manufactures the product (c′).

The changes in physicochemical properties are themselves made explicit by the changes in fluorescence which reveal chemical composition modifications, through natural or neoformed fluorophores, or optical properties, such as absorbance (linked to the color), and scattering (linked to the macromolecular organization).

The calculation of the distance between reduced representations of the spectra, having F variables, constitutes means for quantifying the changes carried out during a technological transformation (a), during storage under specific conditions (b), or between various manufacturing modes (c, c′), which are more or less standard or authentic.

In any event, it is possible to consider a representative population of samples of the reference product, so as to take into account the inevitable variability on said product. Indeed, the differences in spectral signature between the product to be characterized and the reference product are significant only if they exceed those which can be attributed to the variability between samples of the reference product.

This method may constitute a standardization tool at the service of the food-processing industry, making it possible to compare any manufactured product with a target sample, judged to be optimal. It may also constitute a tool for characterizing a storage, transformation or production method; in this case, the focus is not on isolated samples, but on representative populations of such samples, resulting from the method to be characterized.

A method for characterizing one or more samples of an agri-food product, or more broadly any product subjected to a method of manufacture (cosmetic, medicament, etc.), transformation or storage according to the invention, is characterized in that it comprises:

a) illuminating said or each sample to be analyzed with a plurality of excitation light radiations at respective wavelengths;
b) acquiring natural-fluorescence spectra of said or of each sample, each corresponding to a respective excitation light radiation;
c) applying a multivariate or multi-way analysis method to said spectra, which provides a number F of variables representative of said or of each sample, such that said or each sample can be represented by a point in a space having F dimensions;
d) calculating a distance, in said space having F dimensions, between the point representing said or each sample and a target representing one or more reference samples; and
e) determining a characteristic of said or of each sample according to said distance.

In one particularly simple case, the distance calculated can itself be used to express the desired characteristic; in this case, steps d) and e) are carried out jointly.

According to various advantageous characteristics of the invention, taken in isolation or in combination:
Said characteristic can be chosen from a naturality indicator, a freshness indicator, an authenticity indicator and a conformity indicator.
The number F of variables representative of said or of each sample can be between 1 and 10 and preferably between 1 and 5.
Said multivariate or multi-way analysis method can be chosen from a principal component analysis, or PCA; a principal component regression, or PCR; a partial least squares, or PLS, regression; a partial least squares discriminate analysis, or PLS-DA, and a PARAFAC decomposition.
Said distance can be chosen from a Euclidean distance, a Mahalanobis distance and a distance predicted by a regression model.
Said step e) can be carried out by applying a statistical test, such as a Student's test.
Said step b) can consist in acquiring front-face fluorescence spectra.
The method may also comprise, between said steps b) and c), a step b′) of pretreating the acquired fluorescence spectra by subtraction of a contribution due to first-order Rayleigh scatter of the excitation light radiation, said contribution being calculated by means of a generalized linear model.
The number of excitation light radiations, and of corresponding fluorescence spectra for each sample, can be between two and six, and preferably between three and five.
The average spectral gap between said excitation light radiations can be at least 20 nm, and preferably at least 50 nm, over a spectral range of at least 100 nm.

Another subject of the invention is a device for spectroscopic analysis of at least one sample, comprising:
a set of light sources for illuminating said or each sample to be analyzed with respective excitation light radiations, having different wavelengths;
means for acquiring the front-face fluorescence spectra emitted by said or each sample when it is illuminated with said excitation light radiations; and
means for processing the acquired fluorescence spectra, suitable for implementing a method as described above.

According to various advantageous characteristics of the invention, taken in isolation or in combination:
Said device can comprise between two and six, and preferably between three and five, of said light sources, with an average spectral gap of at least 20 nm over a spectral range of at least 100 nm.
Said device can comprise: a first light source emitting a radiation having a wavelength between 270 and 300 nm; a second light source emitting a radiation having a wavelength between 300 and 360 nm; and a third light source emitting a radiation having a wavelength between 400 and 500 nm.

Other characteristics, details and advantages of the invention will emerge on reading the description given with reference to the appended drawings, provided by way of example and which represent, respectively:

FIG. 1, three “raw” spectra of front-face fluorescence of a sample of an agri-food product (roasted chicory), corresponding to three excitations radiations having different wavelengths;

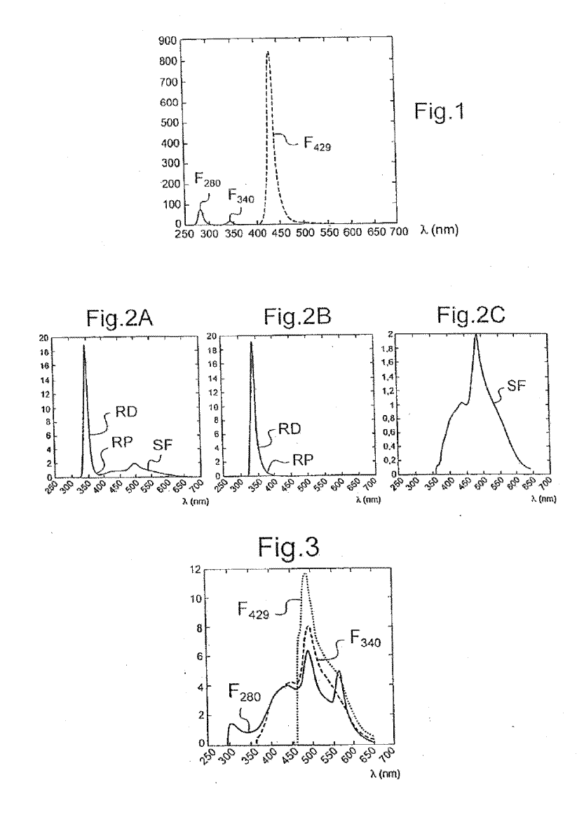

FIGS. 2A, 2B, 2C and 3, four graphs illustrating the operation of subtraction of the Rayleigh scattering by the method using a generalized linear model;

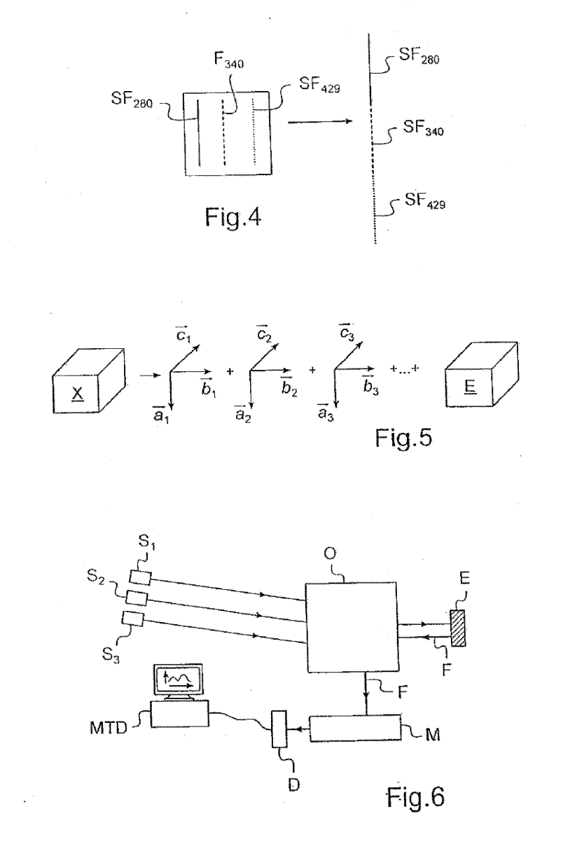

FIG. 4, a diagrammatic illustration of the notion of spectral concatenation;

FIG. 5, a diagrammatic illustration of the PARAFAC factorization;

FIG. 6, the diagram of the principle of an analysis device according to one embodiment of the invention;

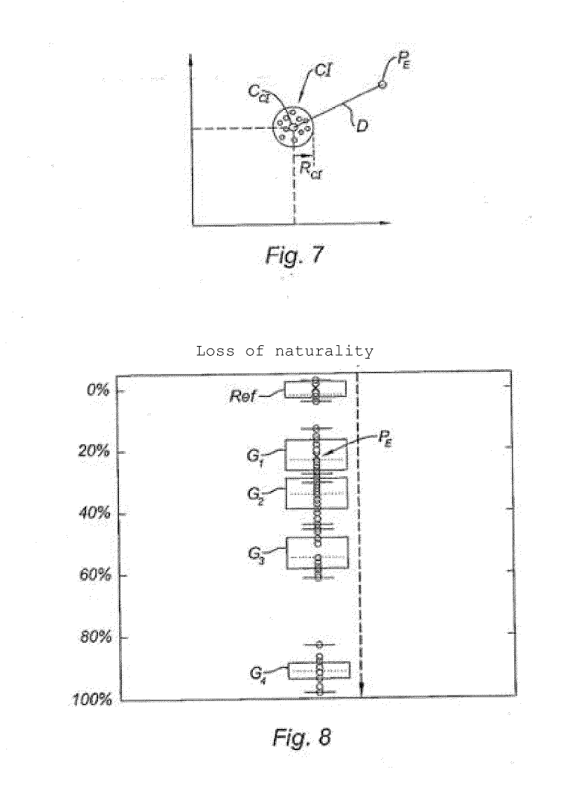

FIG. 7, a diagram of the principle of a method according to one embodiment of the invention;

FIG. 8, a graph illustrating the application of a method according to one embodiment of the invention to the determination of the naturality of a milk sample; and

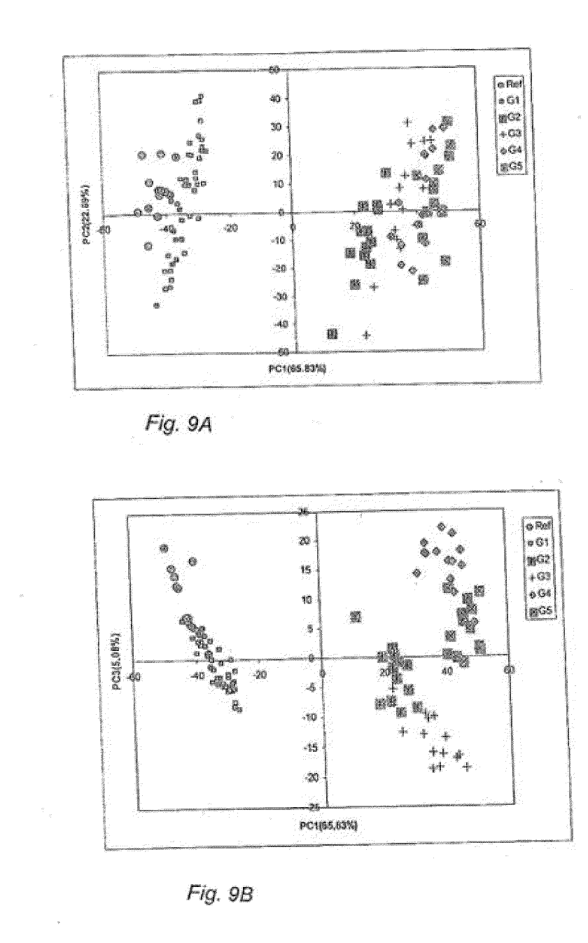

FIGS. 9A and 9B, two graphs of the application of a method according to another embodiment of the invention to the determination of the naturality of various orange juices.

The method according to one embodiment of the invention uses the natural-fluorescence signal emitted at the surface of the food after illumination with light beams having predetermined wavelengths in the UV-visible range (approximately: 250-750 nm). This signal is analyzed by chemometric methods which make it possible to extract the information that correlates with the “naturality” or “freshness” characteristics that it is desired to quantify. The existence of such correlation is deduced from the fact that, during the agricultural production, the storage and the transformation, the intrinsic fluorescence of the natural constituents of the food (vitamins, proteins and other constituents that are natural or intentionally or unintentionally added), and also their reflectance, change, while, at the same time, new signals appear owing to the formation of new molecules. The term “neoformed fluorescence” or “acquired fluorescence” is used depending on whether the fluorophores are formed de novo or originate from the environment. The joint change in the native signals (NS), neoformed signals (NFS) and newly acquired signals (NAS) correlates robustly with the physical, physicochemical, chemical or microbiological modifications of the food, in particular with the changes in the quality parameters, induced during the production, the storage and/or the transformation. The change factors which influence the quality of the food are oxidizing ultraviolet radiation, destruction of microorganisms or, on the contrary, the development of some of them which can lead to the synthesis of mycotoxins, human intervention on crops (fertilizers, pesticides, etc.), or the application of processes which modify the temperature, the pressure or any other physical parameter within the food and which consequently cause a modification of the physicochemical composition and of the quality parameters.

The excitation light radiations have wavelengths chosen so as to explore the UV-visible spectrum as widely as possible. In general, it is possible to choose, a priori:
a wavelength between 270 and 300 nm, making it possible to excite tryptophan, phenols such as chlorogenic acid or hydroxytyrosol or else vitamin E, molecules which emit in the UV range;
a wavelength between 400 and 450 or 500 nm, making it possible to excite riboflavin, porphyrins and chlorophyll, molecules which emit in the visible range (500-700 nm);
one or two wavelengths between 300 and 360 or even 400 nm are introduced in order to excite the neoformed fluorophores, essentially Maillard products and lipid peroxidation products, but also mycotoxins which emit in the far UV-near visible range (400-500 nm).

These wavelengths may be modified according to the specific application. In any event, for greater accuracy, it is possible to choose the wavelengths that are as close as possible to the maxima of the loadings representing the excitation vector obtained by the PARAFAC decomposition of a complete EEM matrix obtained with a laboratory fluorimeter on a batch of representative samples. In general, studying the fluorescence spectra using a visible or ultraviolet excitation radiation provides more information on the transformations undergone by the agri-food products than studying the infrared spectra.

Preferably, the number of wavelengths used is between 2 and 6, advantageously between 3 and 5, and preferably equal to 5, making it possible to excite in turn a corresponding number of groups of fluorophores among those described above. The use of such a restricted number of wavelengths is advantageous for making it possible to implement the method of the invention in an industrial environment. It contrasts with the conventional chemometric techniques, based on the use of a large number of excitation wavelengths. On the other hand, it imposes additional constraints, as will be discussed below.

The intensity of the excitation radiation is chosen such that the fluorescence emission energy of these fluorophores is significantly modified during the transformation (pasteurization, sterilization, etc.) or during the storage of the product to be characterized.

FIG. 6 shows a very simplified scheme of a device for implementing the method of the invention. This device comprises three light sources S₁, S₂, S₃, each emitting a beam of monochromatic radiation at a different wavelength directed so as to illuminate the sample E. The fluorescence signal F (in fact, a mixture of fluorescence and of 1^{st}-order and sometimes 2^{nd}-order Rayleigh scatter) emitted by this sample is transported via an optical fiber to a spectrometer which decomposes the emitted light radiation into a spectrum. The acquired spectra are processed using a data-processing means MTD (typically an appropriately programmed computer) which makes it possible to extract the desired chemometric information therefrom.

The light sources may typically be light-emitting diodes, or even lasers (preferably semiconductor lasers) if greater intensities are required.

The analysis of the spectroscopic data, performed by the MTD computer, comprises four main steps:
preprocessing of the spectra;
application to said spectra of a multivariate or, preferably, multi-way analysis method making it possible to “project” them into a space of reduced dimensions (F dimensions);
calculation of a distance, in said space having F dimensions, between the point representing said or each sample and a target representing one or more reference samples; and
quantitative determination of a characteristic (freshness, naturality, etc.) of said or of each sample according to said distance.

The preprocessing of the spectra, with reference to a specific example, in which a sample of roasted chicory is illuminated successively with three excitation radiations at 280, 340 and 429 nm, is first considered. Each of the three fluorescence spectra consists of 1515 spectral intensity values for as many different wavelengths λ. The spectral resolution is 0.25 nm/pixel, but it can be divided by 5, or even more, without any degradation of the results of the method of the invention being observed.

The “raw” spectra (FIG. 1) are dominated by the first-order Rayleigh scatter, at the wavelength of the excitation radiations (280, 340 and 429 nm). The spectrum of each fluorescence signal, in fact, is partially superimposed on the scattered excitation radiation, which is much more intense. This problem is known, and is generally solved by replacing the intensity values corresponding to the spectral region of superimposition with zeros or missing values. These conventional methods have drawbacks, since the replacement with zeros creates artifacts and therefore distorts the analysis by creating artificial variances. The replacement with missing values creates difficulties in terms of the convergence of the multi-way models used for the data analysis. Furthermore, the presence of the missing values prevents the use of standardization preprocessing (see hereinafter), which can only be applied to real values. These problems are acceptable in the case of techniques based on the use of EEMs with large dimensions, which is the usual case in the prior art, but easily become prohibitive in a method such as that according to the preferred embodiment of the invention, based on the analysis of data with very low resolution in terms of excitation wavelength.

For this reason, it is preferable to eliminate the contribution of the first-order Rayleigh scatter by means of an innovative technique which is based on the prediction of the region of scattering which overlaps the fluorescence via a generalized linear model (GLZ) with a log link function. In this respect, see:
J. Rizkallah, “Chemometric Analysis of Front Face Fluorescence Data-Estimation, of Neoformed Contaminants in Processed Foods.” PhD thesis, Agro Paris Tech France, 2007.
R. Davidson; J. G. MacKinnon “Econometric theory and methods. Generalized least squares and related methods” in “Econometric Theory and Methods”, Oxford University Press 2004, pp. 255-261.

The technique has already been described in French patent application Ser. No. 09/06088 filed on Dec. 16, 2009 in the name of the applicant and not published at the date of filing of the present application.

This model is calibrated on a region of the spectrum in which the contribution of the fluorescence is negligible, and the spectral intensity is attributed exclusively to the scattering (reference RD in FIGS. 2A and 2B).

The generalized linear model has the form:

f(μ_{y})=b₀+b₁x

In the equation, f(μ_{y}) is the link function of μ_{y}, the expected value of y, with y being the vector of the Rayleigh scattering intensities which do not overlap with the fluorescence, while x is a vector of indices (1, 2, 3, etc.) of the same size as y.

With the generalized model, nonlinear relationships (between x and y) can be modeled via the link function. The generalized model can be used to model dependent variables having distributions belonging to the exponential family (Normal, Gamma, Poisson, etc.). Multiple linear regression is a special case of the GLZ model which corresponds to a link function equal to the identity function and to a dependent variable (y) having a normal distribution.

The bᵢ parameters of the GLZ model are estimated by the statistical method of maximization of likelihood (L):

L=F(Y,model)=Πp[yᵢ,bᵢ],
p[yᵢ, bᵢ] being the probability of yᵢ dependent on bᵢ.

The objective is to find the parameters that give the greatest probability (joint density) of producing y for all the observations. An iterative estimation (Fisher algorithm, which is a quasi-Newtonian method) is used to find the bᵢ parameters, while maximizing L:

$$\frac{\partial log ( L )}{\partial {b}_{i}} = 0$$

Once the bᵢ parameters have been estimated, the GLZ model is applied to the scattering indices corresponding to the spectral region superimposed with the fluorescence (FIG. 2B—region of prediction RP) in order to predict the intensities of the “pure” scattering. After this prediction, the complete scattering spectra (real and predicted parts) are subtracted from the EEMs to obtain the spectrum of pure fluorescence SF (FIG. 2C—to be compared with FIG. 2A showing the fluorescence spectrum partially superimposed on the scattered light spectrum).

In FIG. 3, the references F₂₈₀, F₃₄₀ and F₄₂₉ represent the fluorescence spectra relating to the excitations at 280, 340 and 429 nm, respectively, in which the Rayleigh scattering was predicted by application of the generalized model, and subtracted.

The elimination of the Rayleigh scattering is particularly important when the analysis is based on front-face fluorescence spectra of dense and therefore turbid samples. However, the invention can also be implemented on dilute samples, which makes the preprocessing of the data less critical.

The successive operations no longer relate to the three fluorescence spectra considered individually, but to the concatenated spectra, i.e. spectra arranged one after another in a single column (see FIG. 4).

The concatenated spectra can be subjected, as appropriate, to:
a simple standardization by dividing each emission value of each concatenated spectrum by the standard of this same vector Xᵢ. This standardization is applied to each sample (i=1 to I samples), that is:

$${x}_{{ij}_{( standardized )}} = \frac{{x}_{ij}}{‖ {x}_{i .} ‖}$$

where j is the number of wavelengths of the concatenated emission spectrum (j=1 to 4545) and

$$‖ {x}_{i .} ‖ = \sqrt{{\sum }_{j} {\vert {x}_{ij} \vert}^{2}} ;$$

or
a correction by “multiplicative scatter correction” (MSC), which consists in performing a regression between the vector xᵢ (the concatenated emission spectrum of each sample i) and the average concatenated vector of all the samples (i=1 to I samples), then taking away the ordinate at the origin and in dividing each intensity of the concatenated emission spectrum for each sample by the respective slope, as described below:

$${x}_{i .} = {a}_{i} + {b}_{i} {\overline{x}}_{i .}$$

$${x}_{ij} ( MSC ) = \frac{{x}_{ij} - {a}_{i}}{{b}_{i}}$$

In this respect, see the abovementioned publication by R. Bro and also the article by M. S. Dhanoa et al. “The link between multiplicative scatter correction (MSC) and standard normal variate (SNV) transformations of NIR spectra.” J. Near Infrared Spectrosc. 1994, 2, 43-47.

After having acquired and processed the fluorescence spectra of a certain number of calibration samples (at least two, corresponding to extreme values of the parameter to be quantified; preferably more), it is possible to determine the multi-way statistical model that will be used for the analysis of other samples to be characterized. This comprises the calculation of the “loading” vectors of this model.

The case of a trilinear model of “PARAFAC” type is first considered. The principle, shown in FIG. 5, is to decompose a three-way structure (data cube) X into a sum of external three-vector products (“triads”) aᵢ, bᵢ, cᵢ, plus a residue E, which is itself also in the form of a “data cube”. The three ways constituting the “cube” X are: the samples, the excitation radiations and the emission wavelengths. The following can therefore be written:

$${x}_{ijk} = {\sum }_{f = l}^{F} {a}_{if} {b}_{jf} {c}_{kf} + {e}_{ijk} ,$$

where: “i” is the index of the samples, “j” is that of the excitation radiations, “k” is that of the emission wavelengths, and “f” is that of the F PARAFAC decomposition factors.

The concatenation of the spectra makes it possible to write the PARAFAC decomposition in matrix form:

X_{I*JK}=A(C [symbol] B)^{T};

where:
I, J and K are the numbers of samples, of excitation wavelengths and of emission wavelengths, respectively;
X_{I*JK} is the matrix of the concatenated fluorescences of all the samples;
B_{JF} and C_{KF} are the excitation and emission “loading” matrices (of size J*F and K*F elements, respectively) (bilinear fluorescence profiles);
A_{IF} is the matrix (of size I*F) of the “scores” (or intensities of the spectral loadings);
the symbol [symbol] represents the Khatri-Rao tensor product; and
the superscript ^{T} indicates the transpose of the column matrix.

The loading vectors are calculated on the basis of the calibration samples chosen so as to be representative of the total variability expected in the group of samples to be subsequently characterized. For example, if it is desired to quantify the naturality of a product, calibration samples corresponding to fresh products (perfect naturality), others corresponding to highly transformed products (low naturality), and preferably even others corresponding to intermediate naturality values, will be used. The same is true for the other parameters to be quantified. It should be considered that the model is empirical; it is therefore valid only for samples similar to those that were used for the calibration.

The parameters A, B and C of the PARAFAC model can be calculated by the method of alternating least squares (nonlinear iterative method). In this method, a first estimation of the matrix A is calculated conditionally on initial random values assigned to B and C in order to minimize the sum of the squares of the residues. The parameter B is then updated using the estimation of A, and then the parameter C is updated using the new value of B, and so on. Each iterative updating of A, B and C therefore improves the solution (reduction in the error surface). The algorithm converges when the improvement in the solution at the level of an iteration becomes very small (by default, this criterion is 10⁻⁶).

The convergence of the PARAFAC model for data that are weakly resolved and that, furthermore, are not truly trilinear, may be problematic (see the above-mentioned publications by R. Bro and Rizkallah). Indeed, the error surface of the model may contain local minima (points lower than in their vicinity, but higher than the true minimum of the surface), saddle points, flat areas, and very narrow valleys which can slow down or even prevent the convergence of the algorithm.

The present inventors have noted that, by imposing a limitation on the number of iterations (for example, a maximum of 30 iterations) and/or by increasing the convergence criterion (10⁻² or 10⁻² instead of 10⁻⁶), the model is significantly improved at the level of the parameters (loadings and scores). Indeed, an excessive number of iterations can degrade the relevance of the model.

The convergence can be facilitated by imposing a constraint of non-negativity, since it is known, a priori, that the fluorescence spectra and also their relative intensities cannot take negative values.

Finally, it has been noted that the preprocessing for elimination of the Rayleigh scattering by applying a GLZ model facilitates the convergence of the iterative method for calculating the loading and score matrices of the PARAFAC model.

In the case of perfectly trilinear data, the PARAFAC model in theory allows only a single solution. However, in the case of an EEM limited to three excitations, and when the fluorescence is collected at the surface, the trilinearity of the EEM matrix is greatly disrupted. As a result, the solution is no longer a single solution and it is necessary to develop criteria for selecting the number of factors and also the final model.

This choice is guided by several criteria known per se (see the abovementioned reference work by R. Bro):
The verification of the conformity between the spectral parameters obtained (matrices B and C) and the a priori knowledge of the fluorophores present in the sample analyzed;
A criterion known under the name CORCONDIA, which is used to verify the percentage deviation of the model with respect to a perfect trilinear model;
The study of the percentage variance of the fluorescence data explained by the model;
The study of the structure of the residues, which should be random;
The study of the structure of the scores (matrix A) in terms of coherence of the change in scores with respect to what is expected from the application of the transformation on the batch of calibration samples;
The repeatability and reproducibility of the scores, etc.

The PARAFAC model thus constructed is applied to the EEM of each new sample to be characterized or, more generally, to the EEMs of several samples to be characterized at the same time, assembled so as to form a data cube.

The new scores are calculated on the basis of the “loading” matrices B and C of the model, as follows:

A_{new}=(B [symbol] C)⁺*X_{new};

where the superscript + indicates the generalized inverse of the tensor product and X_{new} indicates the concatenated and preprocessed spectral data of the new samples.

PARAFAC decomposition can be considered to be a technique for dimensional reduction of spectroscopic data. Before decomposition, each sample is identified by 3×1515=4545 spectral intensity values; it can therefore be represented by a point in a space with 4545 dimensions. Afterwards, each sample is identified by the F values of the scores: it is therefore represented by a point (reference P_{E} in FIG. 7) in a space of small dimensions. Indeed, F may be chosen as small as 1 or 2.

Other methods of multivariate or multi-way analysis can be used in place of the PARAFAC decomposition. By way of nonlimiting example, mention may be made of principal component analysis, or PCA; principal component regression (PCR); partial least squares (PLS) regression or, better still, partial least squares discriminate analysis (PLS-DA). The PLS-DA method has the advantage of taking into consideration the prior knowledge of the various groups of samples having undergone similar treatments, thereby making it possible to optimize the separation thereof. In the case of the principal component analysis or regression, the coordinates of the points P_{E} will not be given by “scores”, but by “principal components”.

Whatever the method of statistical analysis used, the reference samples form a cloud of points in this space of reduced dimensions. This cloud of points makes it possible to determine a “target”, having in particular the form of an interval (with 1 dimension), circle (with 2 dimensions), sphere (with 3 dimensions) or hypersphere (with more than 3 dimensions). FIG. 7 shows an example in which the number of dimensions is equal to 2; the target CI is a circle characterized by its center C_{CI} (the centroid or barycenter of the cloud of points or, with one dimension, its median) and its radius R_{CI}. This radius can in particular be defined by the confidence interval of the reference points, or by the distance between the center and the most distant point. The number F of dimensions used may be, for example, between 1 and 10 and preferably between 1 and 5.

For each point P_{E}, corresponding to a sample to be characterized, it is possible to determine a distance D from the target (distance measured as a function of the center of the target or of its periphery, according to the embodiment considered). The distance D may be the ordinary Euclidean distance; however, in the case of a PARAFAC factorization, it is preferable to use a Mahalanobis distance, which takes into account the non-perfect independence of the “coordinates” defined by the PARAFAC factors. In any event, it is this distance which makes it possible to quantify the freshness and/or the naturality of the sample.

As a variant, it is possible to define the naturality (or the freshness, the authenticity, etc.) by means of a statistical test such as a Student's test. The procedure is carried out in the following way.

Several duplicates of the front-face fluorescence EEMs of a sample to be characterized and of a reference sample are acquired and arranged in a three-way cube which is decomposed using a PARAFAC model which is written, in matrix form:

X_{I*JK}=A(C [symbol] B)^{T}+E_{I*JK};

where B and C are the excitation “loading” matrices, A is the score matrix and E_{I*JK} is the residue matrix.

A distance indicator vector y is then calculated using a linear regression model:

y=b₁a₁+b₂a₂+ . . . +b_{F}a_{F}+e.

The vector y is binary and takes values of zero for reference samples and of one for the sample to be characterized. The vectors a are the columns of the matrix A, the scalars bᵢ are the coefficients of the linear model, e is the residue vector and F is the number of PARAFAC factors that is required in order to satisfactorily explain the data. A Student's t test is applied to the distances \textcircled{y}ᵢ expected on the basis of the EEMs of the reference sample and distances ŷₛ expected on the basis of the EEMs of the sample to be characterized. The statistic t is calculated via the following equation:

$$t = \frac{( \overline{{\hat{y}}_{r}} - \overline{{\hat{y}}_{s}} )}{\sqrt{\frac{{s}_{{\hat{y}}_{r}}}{{n}_{r}} + \frac{{s}_{{\hat{y}}_{s}}}{{n}_{s}}}} ;$$

where \overline{\textcircled{y}ᵣ}, \overline{\textcircled{y}ₛ}, s_{y1}, s_{y2}, nᵣ and nₛ are respectively the means of the distances anticipated by the linear regression model, the variances thereof and the number of duplicates of EEMs used in the calibration for the reference (index r) and the sample (index s). The naturality is expressed as a function of the probability density:

$$p ( t ) = \frac{Γ ( \frac{v + 1}{2} )}{\sqrt{v π} Γ ( \frac{V}{2} )} {( 1 + \frac{{t}^{2}}{v} )}^{- \frac{1}{2} ( v + 1 )}$$

where Γ is the gamma function and ν is the degree of freedom

$$v = \frac{{( \frac{{S}_{{\hat{y}}_{r}}}{{n}_{r}} + \frac{{S}_{{\hat{y}}_{s}}}{{n}_{s}} )}^{2}}{\frac{{( \frac{{S}_{{\hat{y}}_{r}}}{{n}_{r}} )}^{2}}{( {n}_{r} - 1 )} + \frac{{( \frac{{S}_{{\hat{y}}_{s}}}{{n}_{s}} )}^{2}}{( {n}_{s} - 1 )}} .$$

Samples having a higher external probability, on the basis of the null hypothesis on the distributions (Hₒ \overline{\textcircled{y}ᵣ}= \overline{\textcircled{y}ₛ}), receive better naturality values.

FIG. 8 illustrates the application of a method according to the invention to the determination of the naturality of milk subjected to various heat treatments. These samples were successively exposed to three excitation radiations at 280, 340 and 429 nm. Each of the three fluorescence spectra consists of 1515 spectral intensity values for as many different wavelengths λ. The spectral resolution is 0.25 nm/pixel, but it could be divided by 5, or even more, without degradation of the results of the method of the invention.

The spectra are preprocessed by elimination of the Rayleigh scattering by application of a GLZ model, concatenated, and standardized with SNV methods; then a PCA model is constructed from the preprocessed spectra, and the principal component demonstrating most clearly the difference between the various groups of samples, corresponding to various treatments undergone by the milk, was chosen (in this case, it is the 1^{st} principal component, explaining approximately 65% of the variability of the samples). Descriptive statistics (minimum and maximum values, medians, values of the 1^{st} and 3^{rd} quartile, distance between the centroids of the groups) of the various groups are calculated on the basis of the scores of this principal component. These statistics make it possible to determine whether the groups are actually separated, i.e. whether the distance between their medians is significant.

In FIG. 8, the reference samples, Ref, correspond to raw milk. Other samples were subjected to pasteurization (group G1), direct UHT treatment (G2), indirect UHT treatment (G3) and sterilization (G4). The samples (or, more precisely, their fluorescence spectra) were projected into a space with a single dimension. It can be seen that the groups G1-G4 correspond to a decrease in naturality, as could be expected. The rectangles box in 95% of the variability of each group.

The scale on the left of the graph of FIG. 8 indicates the “loss of naturality”, which is close to 0% for the samples of raw milk (minimal modification) and to 100% for those of sterilized milk (strong modification). The point P_{E} corresponds to a microfiltered milk sample. The loss of naturality (22.2%) is substantially the same as for the pasteurized fresh milk, despite the absence of heating. This is explained by the fact that, in the microfiltered milk, the fat is sterilized.

FIGS. 9A and 9B show the application of a method according to another embodiment of the invention to the determination of the naturality of orange juice. The following were considered:
reference samples (Ref) of fresh orange juice;
samples G1 of fresh orange juice, heated to 100° C. then cooled;
samples G2 of a commercial juice, of a brand M1, 100% pure juice with pulp, subjected to flash pasteurization, sold in the fresh food department;
samples G3 of a concentrate-based juice, with a long shelf life, of this same brand M1;
samples G4 of a commercial juice, of a brand M2, 100% pure juice without pulp, subjected to flash pasteurization, sold in the fresh food department;
samples G5 of a commercial juice, of a brand M3, 100% pure juice without pulp, with a guarantee of vitamin C content, and with a long shelf life.

Fluorescence spectra were acquired and preprocessed in the same way as for the previous example. A principal component analysis was performed, and the first three principal components PC1, PC2 and PC3 were taken into consideration. The 1^{st} principal component PC1 explains 65.83% of the variability of the samples; the 2^{nd} principal component PC2 explains 22.69% of the variability and the 3^{rd} component PC3 only 5.08%. FIG. 9A shows a PC1/PC2 representation, and FIG. 9B a PC1/PC3 representation. It is seen that this second representation separates the various groups most clearly.

In this FIG. 9B, it is noted:
that simple heating, even to 100° C., of the orange juice has only a slight impact on its naturality, measured by the spectral fluorescence signature (the samples G1 are the closest to the reference);
that, on the contrary, the addition of pulp improves the naturality of the juices (the samples G2—fresh with pulp—are appreciably closer to the reference than those of G4, fresh without pulp); and
that the fresh juices show a greater naturality than those with a long shelf life (the samples G2 and G4, which are fresh, are closer to the reference than those of G3 and G5, which have a long shelf life).

The authenticity and/or the conformity of a product are binary parameters: the product is authentic or it is not; it is in conformity or it is not. These parameters can be determined by comparing the distance D of the sample from the centroid of the target to a threshold. For example, this threshold can be equal to R_{CI}: the sample is considered to be authentic/in conformity if its representative point P_{E} is inside the target, adulterated/not in conformity if it is outside the target.

1. A method for characterizing one or more samples of an agri-food product, characterized in that it comprises:
a) illuminating said or each sample to be analyzed with a plurality of excitation light radiations having respective wavelengths;
b) acquiring natural-fluorescence spectra of said or of each sample, each corresponding to a respective excitation light radiation;
c) applying a multi-way analysis method to said spectra, which provides a number F of variables representative of said or of each sample, such that said or each sample can be represented by a point in a space having F dimensions;
d) calculating a distance (D), in said space having F dimensions, between the point representing said or each sample and a target representing one or more reference samples; and
e) determining a characteristic of said or of each sample according to said distance.

2. The method as claimed in claim 1, in which said characteristic is chosen from a naturality indicator, a freshness indicator, an authenticity indicator and a conformity indicator.

3. The method as claimed in claim 1, in which the number F of variables representative of said or of each sample is between 1 and 10.

4. The method as claimed in claim 1, in which said multi-way analysis method is a PARAFAC decomposition.

5. The method as claimed in claim 4, in which said distance is chosen from a Euclidean distance, a Mahalanobis distance and a distance predicted by a regression model.

6. The method as claimed in claim 1, in which said step e) is carried out by application of a statistical test.

7. The method as claimed in claim 1, in which said step b) consists in acquiring front-face fluorescence spectra.

8. The method as claimed in claim 1, also comprising, between said steps b) and c), a step b′) of preprocessing the acquired fluorescence spectra by subtraction of a contribution due to first-order Rayleigh scatter of the excitation light radiation, said contribution being calculated by means of a generalized linear model.

9. The method as claimed in claim 1, in which the number of excitation light radiations, and of corresponding fluorescence spectra for each sample, is between two and six.

10. The method as claimed in claim 1, in which the average spectral gap between said excitation light radiations is at least 20 nm, over a spectral range of at least 100 nm.

11. A device for spectroscopic analysis of at least one sample, comprising:
a set of light sources for illuminating said or each sample to be analyzed with respective excitation light radiations, having different wavelengths;
means for acquiring the front-face fluorescence spectra emitted by said or each sample when it is illuminated by said excitation light radiations; and
means for processing the acquired fluorescence spectra, suitable for implementing a method as claimed in claim 1.

12. The device for spectroscopic analysis as claimed in claim 11, comprising between two and six, of said light sources, with an average spectral gap of at least 20 nm over a spectral range of at least 100 nm.

13. The device as claimed in claim 12, comprising:
a first light source which emits a radiation having a wavelength between 270 and 300 nm;
a second light source which emits a radiation having a wavelength between 300 and 360 nm; and
a third light source which emits a radiation having a wavelength between 400 and 500 nm.

14. The method as claimed in claim 1, in which the number F of variables representative of said or of each sample is between 1 and 5.

15. The method as claimed in claim 1, in which the number of excitation light radiations, and of corresponding fluorescence spectra for each sample, is between 3 and 5.

16. The method as claimed in claim 1, in which the average spectral gap between said excitation light radiations is at least 50 nm, over a spectral range of at least 100 nm.

17. The device for spectroscopic analysis as claimed in claim 11, comprising between three and five, of said light sources, with an average spectral gap of at least 20 nm over a spectral range of at least 100 nm.
